(19) United States
(12) Patent Application Publication
(10) Pub. No.: US 2026/0143267 A1
(43) Pub. Date: May 21, 2026

(54) EARPHONE

(71) Applicant: PANASONIC INTELLECTUAL PROPERTY MANAGEMENT CO., LTD., Osaka (JP)

(72) Inventors: Takashi KIHARA, Fukuoka (JP); Arata MIYAGI, Yamaguchi (JP); Ryota TAKESHIGE, Fukuoka (JP); Daisuke SHIGETOMI, Fukuoka (JP)

(73) Assignee: PANASONIC INTELLECTUAL PROPERTY MANAGEMENT CO., LTD., Osaka (JP)

(21) Appl. No.: 19/388,727

(22) Filed: Nov. 13, 2025

(30) Foreign Application Priority Data
Nov. 18, 2024 (JP) 2024-201088

(51) Int. Cl. H04R 1/02; H04R 1/10

(52) U.S. Cl. CPC H04R 1/023; H04R 1/1016; H04R 1/1075

(57) ABSTRACT

An earphone includes an earphone main body and an earpiece attached to the earphone main body. The earphone main body includes a housing inside which a speaker unit is incorporated, and a cylindrical sound conduit that protrudes from the housing and has a sound emitting hole for emitting a sound emitted from the speaker unit to the earpiece. An annular recess formed by enlarging an inner diameter of the sound conduit is provided at a distal end of the sound conduit. A dustproof mesh in which a first opening communicating with the sound emitting hole is formed is provided in the annular recess.

### CROSS-REFERENCE TO RELATED APPLICATIONS

This application is based on and claims priority under 35 USC 119 from Japanese Patent Application No. 2024-201088 filed on November 18, 2024, the contents of which are incorporated herein by reference.

### TECHNICAL FIELD

The present disclosure relates to an earphone.

### BACKGROUND ART

Patent Literature 1 discloses an earphone including a sound emitting unit, a sound collecting unit, a housing in which the sound emitting unit and the sound collecting unit are accommodated, a sound hole formed inside the housing and configured to propagate a sound emitted from the sound emitting unit to the sound collecting unit, and an ear pad covering at least a part of the sound hole. In this earphone, a dustproof mesh is provided on an ear pad lateral end surface which is an end surface of the ear pad, and a mesh is provided between a sound hole lateral end surface and the dustproof mesh, thereby achieving a dustproof effect.

### CITATION LIST

### PATENT LITERATURE

Patent Literature 1: JP6898008B2

### SUMMARY OF INVENTION

However, in the earphone of Patent Literature 1, since the dustproof mesh blocks the sound hole, the dustproof mesh can collect a foreign matter such as dust, but the collected foreign matter spreads over the entire dustproof mesh due to an influence of a surface free energy, and the foreign matter is likely to accumulate in a central portion (portion blocking sound hole) of the dustproof mesh. That is, in the earphone of Patent Literature 1, there is a possibility that the quality (in particular, sound quality) of the earphone is reduced, such as a case where the foreign matter is accumulated in the central portion of the dustproof mesh according to a use period, and a sound emitted through the sound hole is difficult to be heard due to the accumulated foreign matter. Therefore, in the earphone of Patent Literature 1, a frequency of performing maintenance such as cleaning to remove a foreign matter adhering onto the dustproof mesh and replacement of a member including the dustproof mesh with a new one tends to increase (maintenance cycle tends to be shortened).

The present disclosure has been made in view of the above-described situation in the related art, and an object of the present disclosure is to provide an earphone that can prevent a foreign matter from intruding into an inside of a housing more appropriately and can extend a maintenance cycle.

An earphone according to the present disclosure includes an earphone main body and an earpiece attached to the earphone main body. The earphone main body includes a housing inside which a speaker unit is incorporated, and a cylindrical sound conduit that protrudes from the housing and has a sound emitting hole for emitting a sound emitted from the speaker unit to the earpiece. An annular recess formed by enlarging an inner diameter of the sound conduit is provided at a distal end of the sound conduit. A dustproof mesh in which a first opening communicating with the sound emitting hole is formed is provided in the annular recess.

According to the earphone of the present disclosure, it is possible to more appropriately prevent a foreign matter from intruding into the inside of the housing and to extend the maintenance cycle.

### BRIEF DESCRIPTION OF DRAWINGS

FIG. 1 is a perspective view of an earphone according to Embodiment 1;

FIG. 2 is an exploded perspective view of a main part of the earphone illustrated in FIG. 1;

FIG. 3 is a schematic cross-sectional view illustrating a sound conduit and vicinity thereof of the earphone illustrated in FIG. 1;

FIG. 4 is a perspective view of the sound conduit of the earphone illustrated in FIG. 1 as viewed from an upper side;

FIG. 5 is a view illustrating Modification 1 of a dustproof mesh according to Embodiment 1 and corresponds to FIG. 4;

FIG. 6 is a view illustrating Modification 2 of the dustproof mesh according to Embodiment 1 and corresponds to FIG. 4;

FIG. 7 is a view illustrating an earphone according to Embodiment 2 and corresponds to FIG. 3;

FIG. 8 is a perspective view of the sound conduit of the earphone illustrated in FIG. 7 as viewed from the upper side and corresponds to FIG. 4 and

FIG. 9 is a view illustrating intrusion of a foreign matter into an earphone.

### DESCRIPTION OF EMBODIMENTS

### Background of Present Disclosure

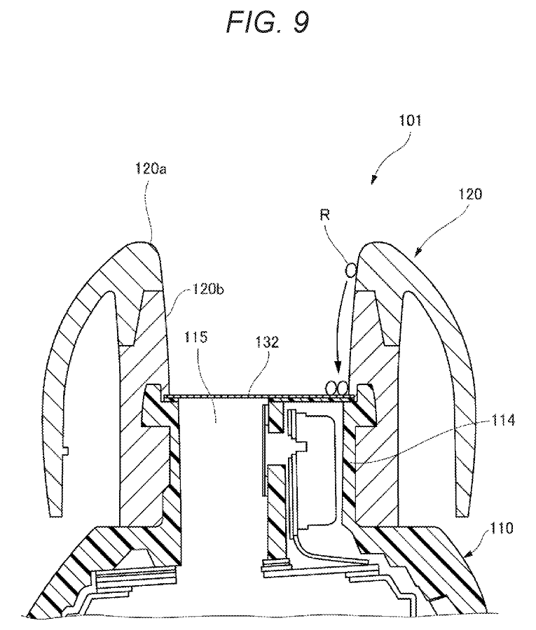

FIG. 9 is a view illustrating intrusion of a foreign matter into an earphone 101. Hereinafter, for convenience of description, the intrusion of a foreign matter into the earphone will be described with reference to FIG. 9, but the intrusion of a foreign matter is a problem that may generally occur when the earphone is used.

In general, in the earphone 101, a foreign matter R such as dirt, dust, or earwax intrudes into an earphone main body 110 through a tip 120a of an earpiece 120. The foreign matter R often intrudes along an inner peripheral wall 120b of the earpiece 120 particularly when the earphone 101 is used. Basically, the foreign matter R intruding as described above first accumulates in a periphery of an acoustic mesh 132 provided in a sound conduit 114, and gradually spreads to a center of the acoustic mesh 132. Therefore, in a case where the earphone 101 is used for a long period of time, the foreign matter R may accumulate in the entire acoustic mesh 132 or may pass through the acoustic mesh 132 and intrude into an inside of the earphone main body 110. In this case, there is a high possibility that a sound emitted through a sound emitting hole 115 is difficult to be heard, or a speaker unit (not illustrated) incorporated inside the earphone main body 110 is damaged. Thus, a maintenance cycle of the earphone 101 is shortened or the life of the earphone 101 is shortened.

Hereinafter, embodiments of the present disclosure will be described in detail with reference to the drawings as appropriate. However, an unnecessarily detailed description may be omitted. For example, a detailed description of well-known matters and the redundant description of substantially the same configuration may be omitted. This is to avoid unnecessary redundancy of the following description and to facilitate understanding of those skilled in the art. The accompanying drawings and the following description are provided for those skilled in the art to fully understand the present disclosure, and are not intended to limit the subject matters described in the claims.

Embodiment 1

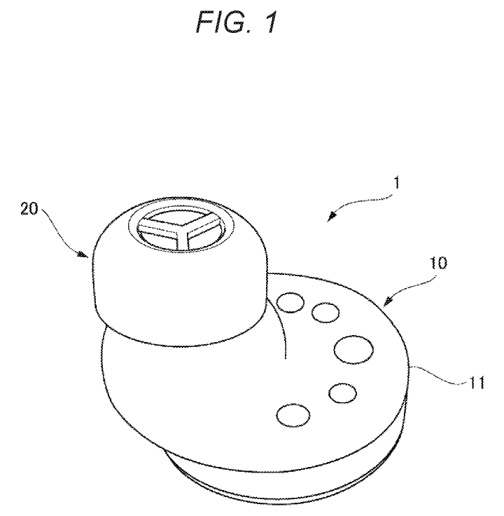

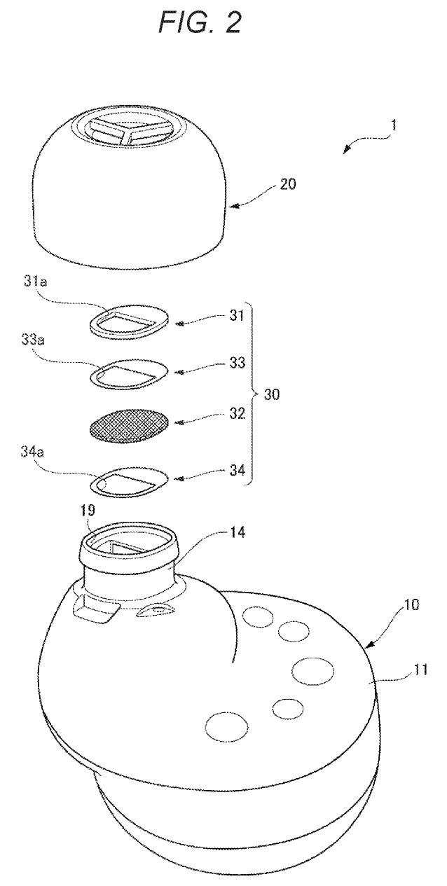

FIG. 1 is a perspective view of an earphone 1 according to Embodiment 1. FIG. 2 is an exploded perspective view of a main part of the earphone 1 illustrated in FIG. 1. As illustrated in FIG. 1, the earphone 1 includes an earphone main body 10 and an earpiece 20.

Although a detailed description of the earpiece 20 is omitted, for example, the earpiece 20 is formed of elastomer or rubber such as silicon rubber, and includes a substantially cylindrical base portion attached to the sound conduit 14 (refer to the following description) and an umbrella portion that seals an ear hole. As the earpiece 20, a known earpiece having a configuration different from the above-described configuration may be used, and the configuration is not particularly limited.

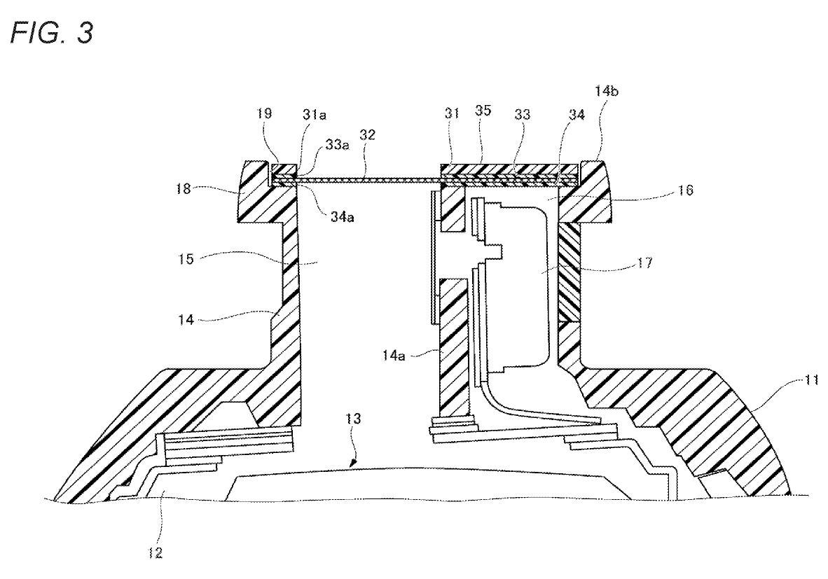

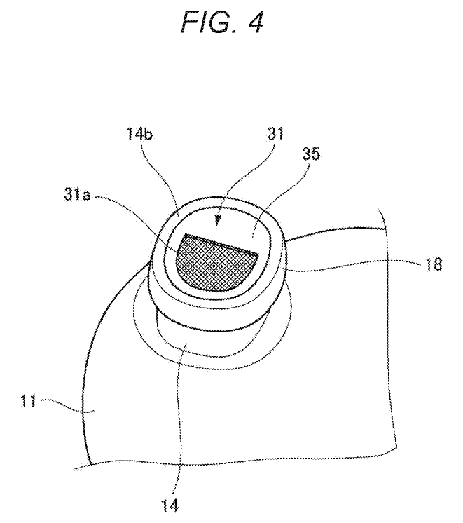

FIG. 3 is a schematic cross-sectional view illustrating the sound conduit 14 and vicinity thereof of the earphone 1 illustrated in FIG. 1. FIG. 4 is a perspective view of the sound conduit 14 of the earphone 1 illustrated in FIG. 1 as viewed from an upper side. As illustrated in FIG. 3, the earphone main body 10 includes a housing 11 and a speaker unit 13. An inside of the housing 11 is an accommodation space 12, and the speaker unit 13 and the like are accommodated in the accommodation space 12.

The housing 11 is provided with the substantially cylindrical sound conduit 14 protruding therefrom, and the earpiece 20 is attached to the sound conduit 14. The sound conduit 14 has a sound emitting hole 15 communicating with the accommodation space 12, and a sound (vibration) emitted from the speaker unit 13 is emitted to the earpiece 20 through the sound emitting hole 15. The sound emitting hole 15 is provided side by side with a microphone accommodation portion 16 (refer to the following description) in an inner space of the sound conduit 14. In other words, the sound conduit 14 is provided with a partition wall 14a that divides the inner space thereof into the sound emitting hole 15 and the microphone accommodation portion 16.

The earphone main body 10 further includes a feedback microphone 17 for realizing a noise cancelling function. The feedback microphone 17 is accommodated in the above-described microphone accommodation portion 16. Specifically, the feedback microphone 17 is assembled to the partition wall 14a in the microphone accommodation portion 16. As the feedback microphone 17, for example, a known feedback microphone may be used, and a configuration thereof is not particularly limited.

The earphone main body 10 may include a feedforward microphone in order to realize the noise cancelling function. In this case, a more excellent noise cancelling function can be realized by combining the feedback microphone 17 and the feedforward microphone.

A retaining flange 18 for retaining the earpiece 20 is provided at a distal end (upper end) of the sound conduit 14, and the retaining flange 18 is formed so as to expand in a diameter enlarging direction with respect to an outer peripheral surface of the sound conduit 14. That is, the retaining flange 18 is formed in a flange shape.

The distal end of the sound conduit 14 is provided with an annular recess 19 formed by enlarging an inner diameter of the sound conduit 14. The annular recess 19 is an annular recess in which an inner peripheral surface of the distal end of the sound conduit 14 is recessed in the diameter enlarging direction over the entire region in a circumferential direction. A laminated member 30 (refer to the following description) is provided in the annular recess 19.

In the present description, unless otherwise specified, the upper side is a side (corresponding to upper side of paper surface) on which a sound passing through the sound conduit 14 is emitted from the sound emitting hole 15, and a lower side is a side (corresponding to lower side of paper surface) on which the speaker unit 13 is accommodated.

As illustrated in FIGS. 2 and 3, the laminated member 30 includes a dustproof mesh 31, an acoustic mesh 32, and double-sided tapes 33 and 34.

The dustproof mesh 31 is a sheet-like member for preventing a foreign matter from intruding into an inside of the housing 11. The dustproof mesh 31 is formed with an outer peripheral shape corresponding to an inner peripheral shape of the annular recess 19, and a first opening 31a communicating with the sound emitting hole 15 is formed at a position corresponding to the sound emitting hole 15 (see also FIG. 4).

The first opening 31a is formed in a shape corresponding to an opening shape of the sound emitting hole 15, and it is preferable that an opening area of the first opening 31a substantially coincides with an opening area of the sound emitting hole 15 from the viewpoint of ensuring an effect of preventing intrusion of a foreign matter and the sound quality. However, a size of the opening area of the first opening portion 31a with respect to the opening area of the sound emitting hole 15 is not limited as long as the effect of preventing intrusion of a foreign matter and the sound quality can be ensured.

The acoustic mesh 32 is a mesh-like or porous plate-like member for dampening (controlling) vibration of the sound transmitted from the sound emitting hole 15. The acoustic mesh 32 is formed with an outer peripheral shape corresponding to the inner peripheral shape of the annular recess 19 and blocks the sound emitting hole 15. Therefore, the acoustic mesh 32 can collect a foreign matter passing through the first opening 31a of the dustproof mesh 31. That is, the acoustic mesh 32 has not only a function related to a sound but also the function of preventing intrusion of a foreign matter.

The double-sided tape 33 is a tape-like member for attaching the dustproof mesh 31 and the acoustic mesh 32. For example, the double-sided tape 33 is formed with an outer peripheral shape corresponding to the outer peripheral shape of the dustproof mesh 31, and an opening 33a is formed at a position corresponding to the first opening 31a.

The double-sided tape 34 is a tape-like member for attaching the laminated member 30 to the annular recess 19. For example, the double-sided tape 34 is formed with an outer peripheral shape corresponding to the outer peripheral shape of the dustproof mesh 31, and an opening 34a is formed at a position corresponding to the first opening 31a. The double-sided tape 34 may be the same as the double-sided tape 33.

The laminated member 30 includes the dustproof mesh 31, the double-sided tape 33, the acoustic mesh 32, and the double-sided tape 34 laminated in this order from the upper side, and is attached to the annular recess 19 via the double-sided tape 34. In a state in which the laminated member 30 is attached to the annular recess 19, as illustrated in FIG. 3, a top surface 35 of the dustproof mesh 31, which is an upper end surface of the laminated member 30, is set to be positioned on a lower side with respect to a distal end surface 14b of the sound conduit 14. However, the top surface 35 may be flush with the distal end surface 14b.

The laminated member 30 may have a configuration including only the dustproof mesh 31 and the double-sided tape 34 as long as it is not necessary to dampen (control) the vibration of the sound. However, from the viewpoint of preventing intrusion of a foreign matter, it is preferable that the laminated member 30 have a configuration including the dustproof mesh 31, the acoustic mesh 32, and the double-sided tapes 33 and 34.

As described above, in the earphone 1, the dustproof mesh 31 in which the first opening 31a communicating with the sound emitting hole 15 is formed is provided in the annular recess 19 of the sound conduit 14. In other words, in the earphone 1, the dustproof mesh 31 is disposed at a portion where the foreign matter is relatively likely to accumulate. As a result, it is possible to efficiently and effectively prevent a foreign matter from intruding into the inside of the housing 11. In addition, since the dustproof mesh 31 is formed in the above-described shape, for example, a surface free energy acts as a force for attracting the foreign matter, and the foreign matter becomes difficult to pass through the first opening 31a, and the foreign matter tends to easily accumulate on the top surface 35 of the dustproof mesh 31. Therefore, the earphone 1 can more appropriately prevent the foreign matter from intruding into the inside of the housing 11 and can extend the maintenance cycle.

Further, in the earphone 1, the acoustic mesh 32 is provided between the annular recess 19 and the dustproof mesh 31. Accordingly, even when the foreign matter passes through the first opening 31a of the dustproof mesh 31, the foreign matter can be collected by the acoustic mesh 32, so that the foreign matter can be more appropriately prevented from intruding into the inside of the housing 11.

(Modification 1 of Dustproof mesh According to Embodiment 1)

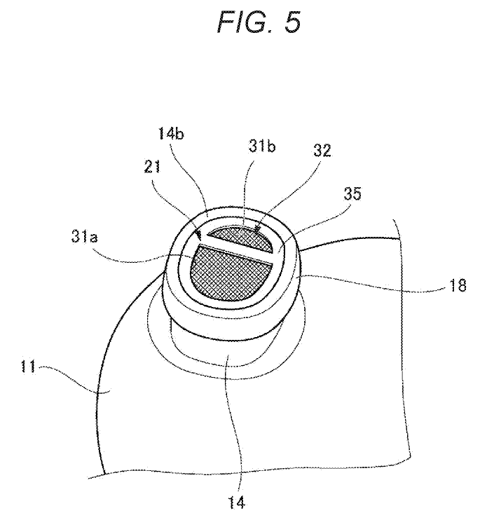

FIG. 5 is a view illustrating Modification 1 of the dustproof mesh 31 according to Embodiment 1 and corresponds to FIG. 4. As illustrated in FIG. 5, the dustproof mesh 31 may be provided with a second opening 31b that allows a part of the acoustic mesh 32 to expose.

With such a configuration, the foreign matter can be collected on the exposed portion of the acoustic mesh 32 through the second opening 31b. In other words, by providing the second opening 31b in the dustproof mesh 31 in order to collect the foreign matter at a predetermined position of the acoustic mesh 32, it is possible to more appropriately prevent the foreign matter from intruding into the inside of the housing 11.

Modification 2 of Dustproof mesh According to Embodiment 1

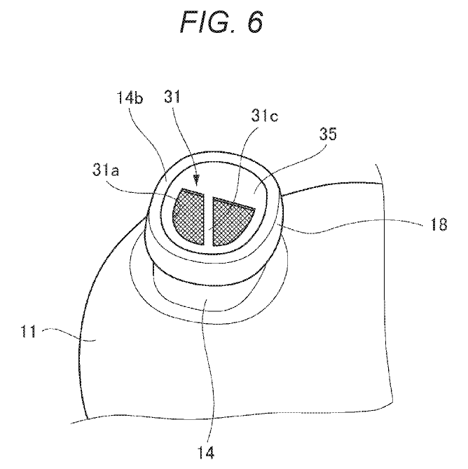

FIG. 6 is a view illustrating Modification 2 of the dustproof mesh 31 according to Embodiment 1 and corresponds to FIG. 4. As illustrated in FIG. 6, the dustproof mesh 31 may be provided with a rib 31c extending across the first opening 31a.

With such a configuration, since the first opening 31a is divided into a plurality of portions and the opening area thereof is reduced, the foreign matter passing through the first opening 31a can be reduced, and the foreign matter can be more appropriately prevented from intruding into the inside of the housing 11. However, the rib 31c needs to be provided so as not to reduce the sound quality of the earphone 1. That is, a plurality of ribs 31c may be provided as long as the sound quality of the earphone 1 is not reduced.

Embodiment 2

In a description of the earphone 1 according to Embodiment 2, the same configuration as that of the earphone 1 according to Embodiment 1 will not be described.

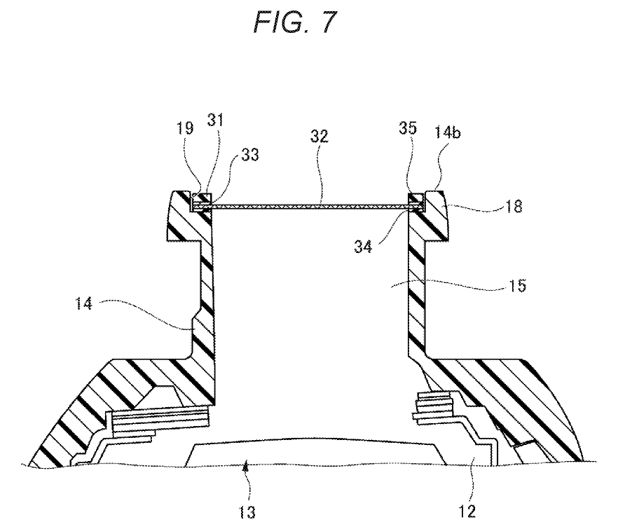

FIG. 7 is a view illustrating the earphone 1 according to Embodiment 2 and corresponds to FIG. 3. As illustrated in FIG. 7, in Embodiment 2, a case where the microphone accommodation portion 16 is not provided in the inner space of the sound conduit 14 is described as an example.

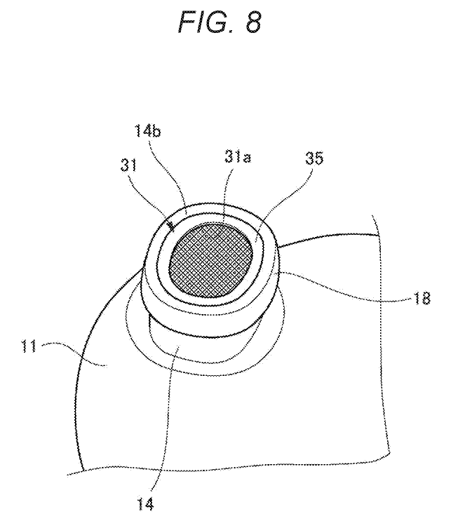

FIG. 8 is a perspective view of the sound conduit of the earphone illustrated in FIG. 7 as viewed from the upper side and corresponds to FIG. 4. As described above, in the earphone 1 according to Embodiment 2, since the microphone accommodation portion 16 is not provided in the inner space of the sound conduit 14, the inner space of the sound conduit 14 functions directly as the sound emitting hole 15. Therefore, as illustrated in FIG. 8, the outer peripheral shape of the dustproof mesh 31 is formed in a ring shape as illustrated.

Also in the earphone 1 according to Embodiment 2, the earphone main body 10 may include the feedback microphone 17. In this case, the feedback microphone 17 may be accommodated in the accommodation space 12, for example.

Only the configuration and structure described above are differences between Embodiment 1 and Embodiment 2, and other configurations and structures of the earphone 1 according to Embodiment 2 are basically the same as those of the earphone 1 according to Embodiment 1. Therefore, also in Embodiment 2, the same functions and effects as those of Embodiment 1 can be obtained.

Summary of Embodiments 1 and 2

The following techniques are disclosed based on the above-described descriptions of Embodiments 1 and 2.

Technique 1

An earphone (1) including: an earphone main body (10); and an earpiece (20) attached to the earphone main body (10), in which the earphone main body (10) includes a housing (11) inside which a speaker unit (13) is incorporated, and a substantially cylindrical sound conduit (14) provided to protrude from the housing (11) and having a sound emitting hole (15) for emitting a sound emitted from the speaker unit (13) to the earpiece (20), an annular recess (19) formed by enlarging an inner diameter of the sound conduit (14) is provided at a distal end of the sound conduit (14), and a dustproof mesh (31) in which a first opening (31a) communicating with the sound emitting hole (15) is formed is provided in the annular recess (19).

According to this configuration, since the dustproof mesh in which the first opening communicating with the sound emitting hole is formed is provided in the annular recess, the foreign matter intruding along an inner peripheral wall of the earpiece is less likely to fall into the first opening due to an influence of the surface free energy or the like, and is likely to accumulate on a periphery of the dustproof mesh. In other words, according to the above configuration, since the foreign matter can intensively accumulate on the periphery of the dustproof mesh, it is possible to more appropriately prevent the foreign matter from intruding into the inside of the housing and to extend the maintenance cycle.

Technique 2

The earphone (1) according to technique 1, in which

an acoustic mesh (32) is provided between the annular recess (19) and the dustproof mesh (31).

According to this configuration, even when the foreign matter temporarily passes through the first opening of the dustproof mesh, the foreign matter can be collected by the acoustic mesh, and therefore, the foreign matter can be prevented from intruding into the inside of the housing.

Technique 3

The earphone (1) according to technique 2, in which the dustproof mesh (31) and the acoustic mesh (32) are laminated, and a second opening (31b) that allows a part of the acoustic mesh (32) to expose is provided in the dustproof mesh (31).

According to this configuration, the foreign matter can be collected on the part of the acoustic mesh exposed through the second opening of the dustproof mesh.

Technique 4

The earphone (1) according to any of techniques 1 to 3, in which the dustproof mesh (31) is provided with a rib (31c) extending across the first opening (31a).

According to this configuration, since the first opening is divided into a plurality of portions and the opening area thereof is reduced, the foreign matter passing through the first opening can be reduced, and the foreign matter can be more appropriately prevented from intruding into the inside of the housing.

Technique 5

The earphone (1) according to any of techniques 1 to 4, in which the dustproof mesh (31) is provided such that a top surface (35) thereof is flush with a distal end surface (14b) of the sound conduit (14) or is positioned on a base end side (lower side in FIG. 3) of the sound conduit (14).

According to this configuration, since the dustproof mesh does not protrude toward the upper side with respect to the distal end surface, a user or the like is less likely to come into contact with the dustproof mesh, and the dustproof mesh is less likely to be detached from the annular recess.

Although the embodiments have been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the embodiment described above may be combined freely within a range without departing from the gist of the invention.

### INDUSTRIAL APPLICABILITY

The technique of the present disclosure is useful for canal type and inner ear type earphones.

What is claimed is:

1. An earphone comprising:
an earphone main body; and
an earpiece attached to the earphone main body, wherein
the earphone main body includes
a housing inside which a speaker unit is incorporated, and
a cylindrical sound conduit that protrudes from the housing and has a sound emitting hole for emitting a sound emitted from the speaker unit to the earpiece,
an annular recess formed by enlarging an inner diameter of the sound conduit is provided at a distal end of the sound conduit, and
a dustproof mesh in which a first opening communicating with the sound emitting hole is formed is provided in the annular recess.

2. The earphone according to claim 1, wherein
an acoustic mesh is provided between the annular recess and the dustproof mesh.

3. The earphone according to claim 2, wherein
the dustproof mesh and the acoustic mesh are laminated, and
the dustproof mesh is provided with a second opening that exposes a part of the acoustic mesh.

4. The earphone according to claim 1, wherein
the dustproof mesh is provided with a rib extending across the first opening.

5. The earphone according to claim 1, wherein
the dustproof mesh is provided such that a top surface thereof is flush with a distal end surface of the sound conduit or is positioned on a base end side of the sound conduit.
